(19) United States
(12) Patent Application Publication
(10) Pub. No.: US 2005/0249051 A1
(43) Pub. Date: Nov. 10, 2005

(54) Timepiece

(76) Inventors: Philippe Cogoli, Kingston-Upon-Thames (GB); Thomas Bolt, London (GB); Jean-Francois Thalheim, Bevaix (CH); Cyril Cuche, Cernier (CH); Julien Loutenbach, Courtedoux (CH); Jaime Antonio Cordova, La Chaux-de-Fonds (CH)

Correspondence Address: YOUNG & THOMPSON, 745 SOUTH 23RD STREET, 2ND FLOOR, ARLINGTON, VA, 22202, US

(21) Appl. No.: 11/085,141

(22) Filed: Mar. 22, 2005

(30) Foreign Application Priority Data
Mar. 24, 2004 (CH) 497/04

(51) Int. Cl. G04B 29/00

(52) U.S. Cl. 368/319

(57) ABSTRACT

The timepiece comprises a case (1), a mechanism (6) disposed in the case (1) and a rotatable control member (10) manipulable by a user, and is characterized in that the rotatable control member (10) is movable in translation relative to the case (1) in a direction substantially perpendicular to the axis (A) of the rotatable control member (10), between first and second positions, and in that in at least one of these first and second positions a rotation of the rotatable member (10) controls a function of the mechanism (6).

The present invention relates to a timepiece.

In timepieces such as wristwatches, the winding and setting functions are controlled by means of a rotatable control member called a “crown”.

Generally, these crowns project from the edge wall and in a radial direction of the watchcase, and are axially movable between a pressed position in which rotation of the crown controls the winding of the watch and a pulled position in which rotation of the crown controls the time setting.

There is however known from FR 1 181 584 a winding and setting device comprising a crown that projects on the upper face of the watch such that its axis is perpendicular to the plane of the movement. This crown can take a first axial position, or upper position, in which it coacts with a winding mechanism and a second axial position, or lower position, in which it coacts with a setting mechanism, a return spring returning the crown to the upper position as soon as it is released by the user.

There is also known from EP 1 310 839 a winding and setting device comprising a crown projecting from the upper face of the watch, which crown is adapted to drive in rotation a control rod axially movable in the plane of the movement and actuable by the user. When the control rod is in an axial pressed position, rotation of the crown by the user and transmitted by the crown to the control rod causes winding of the watch. When the control rod is in an axial pulled position, rotation of the crown by the user and transmitted by the crown to the control rod permits setting the watch.

In all the devices mentioned above, the change from the winding position to the setting position, and conversely, is achieved by axial movement of a control member (crown or control rod connected to the crown).

The present invention seeks to provide an alternative to these devices.

To this end, there is provided a timepiece comprising a case, a mechanism disposed in the case and a rotatable control member manipulable by a user, characterized in that the rotatable control member is movable in translation relative to the case in a direction substantially perpendicular to the axis of the rotatable control rod, between first and second positions, and in that in at least one of the first and second positions a rotation of the rotatable member controls a function of the mechanism.

In addition to the particular effect that will be produced on the user, accustomed to crowns that are pushed and pulled axially, the present invention has several advantages. It permits particularly mounting the rotatable control member perpendicular to the plane of the movement, so that it will project for example on the upper face of the timepiece, and this without requiring providing a specific movement, as is the case in FR 1 181 584, nor providing two different control members separately manipulable by the user, namely a crown movable in rotation and a control rod movable in translation, as in EP 1 310 839.

Particular embodiments of the invention are defined in the accompanying dependent claims 2 to 11.

Other characteristics and advantages of the present invention will become apparent from the following detailed description given with reference to the accompanying schematic drawings, in which:

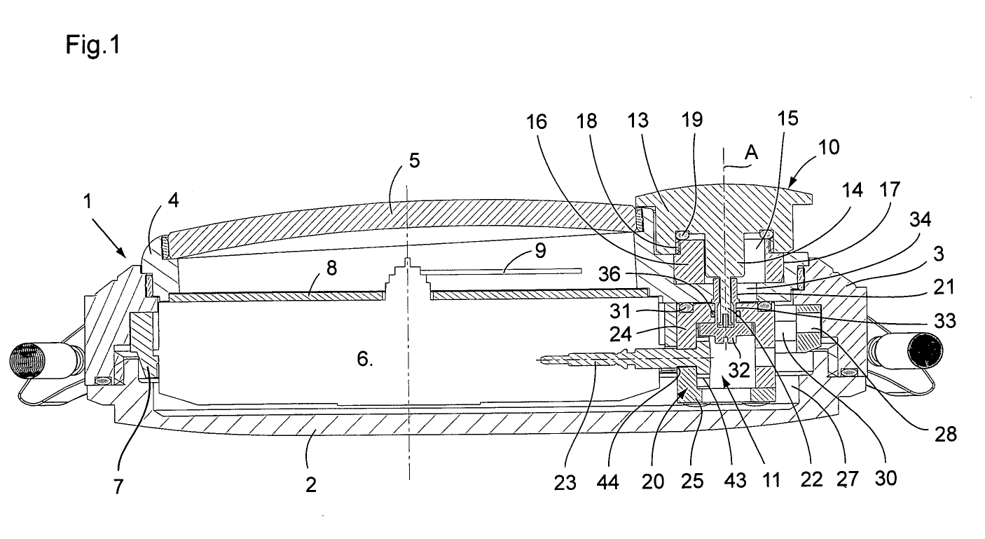

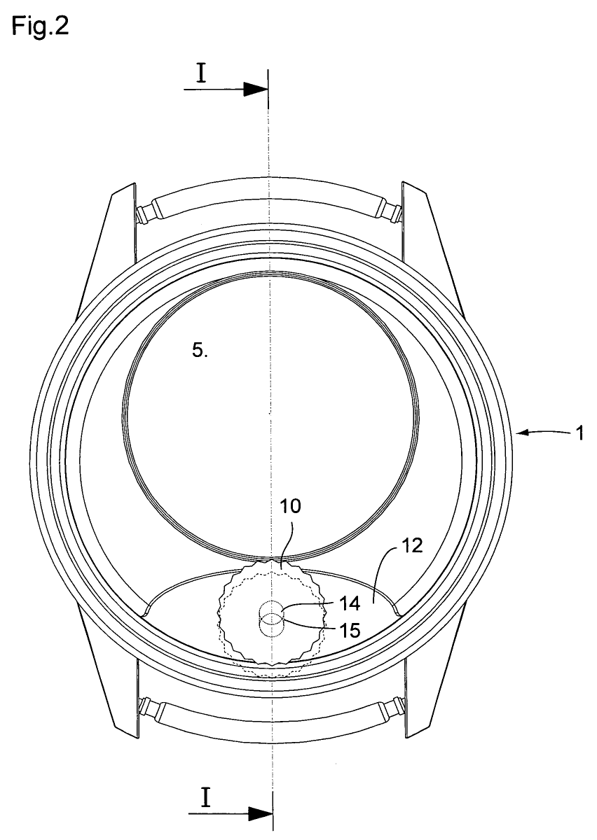

FIG. 1 is a sectional view of the timepiece according to the invention, taken on the line I-I of FIG. 2, and showing the crown of the timepiece in a screwed position;

FIG. 2 is a top view of the timepiece according to the invention, showing the crown in a first radial unscrewed position (full line) and a second radial unscrewed position (dotted line);

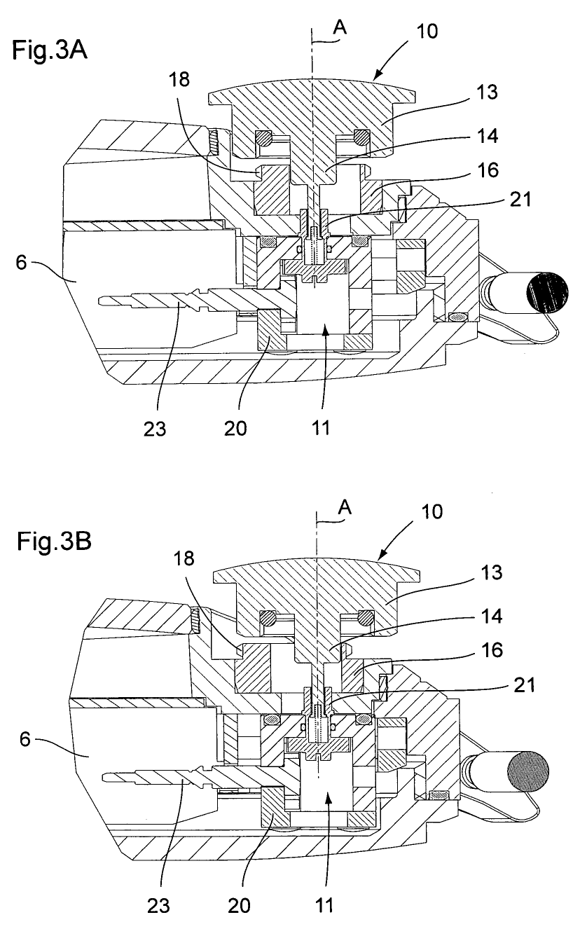

FIGS. 3A and 3B are partial sectional views of the timepiece according to the invention, showing the crown in its two radial unscrewed positions, respectively;

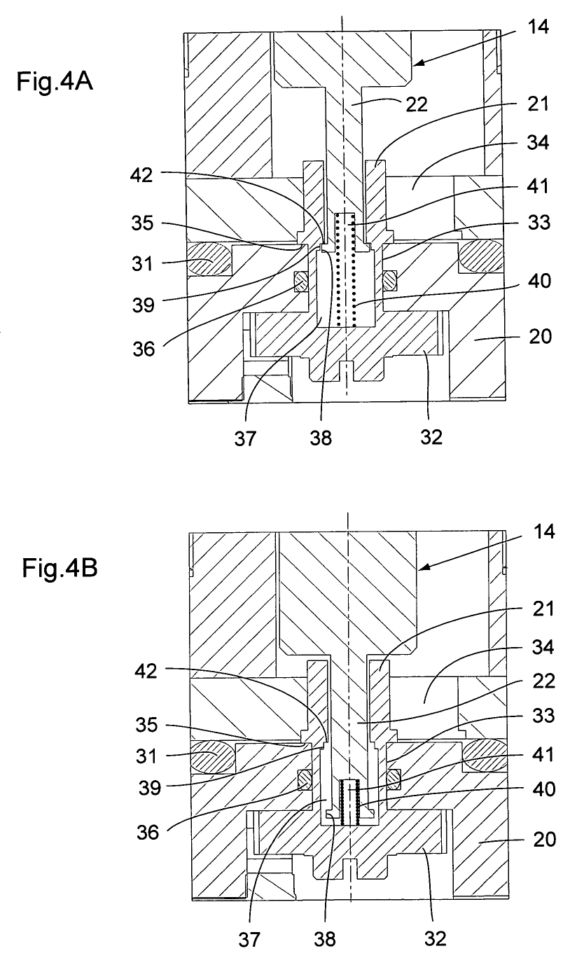

FIGS. 4A and 4B are sectional views showing the connection between the crown and a crown rod of the timepiece according to the invention when the crown is in the first radial unscrewed position and in the screwed position, respectively;

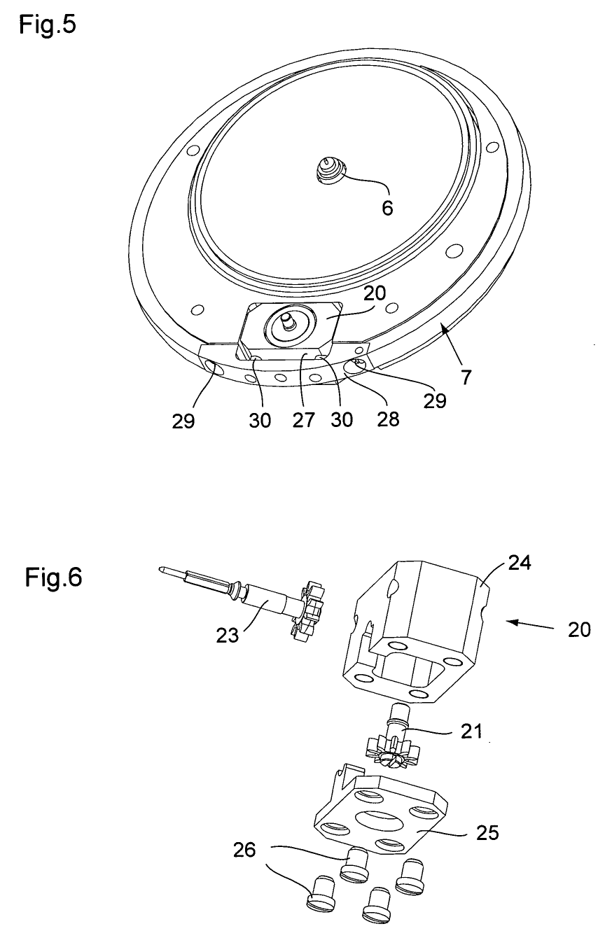

FIG. 5 is a perspective view of a circle of the timepiece according to the invention, in which is mounted a movement and, at the periphery, a cage connected to the crown;

FIG. 6 is an exploded perspective view of the cage.

In the context of the present patent application, there is meant by the rotation of a rotatable member such as a crown or a rod, a rotation about the axis of this rotatable member. Moreover, in all the following description, the term “radial” will be used to refer to a radial direction relative to the watchcase, whilst the term “axial” will relate to an axial direction relative to the element in question, crown or rod.

With reference to the accompanying drawings, in particular FIG. 1, a timepiece according to the invention, of the wristwatch type, comprises: a watchcase 1 of circular shape constituted by a back cover 2, a middle part 3 and a bezel 4 bearing a crystal 5; a movement 6 mounted in a circle 7 within the watchcase 1 and supporting a dial 8 and hands 9; a rotatable control member or crown 10; and a connection mechanism 11 connecting the crown 10 to the movement 6 to permit control of certain functions of the movement 6, such as winding and setting.

The crown 10 projects from the upper face of the watchcase, in a recess 12 of this face (see FIG. 2), and its axis, designated by the reference A, is perpendicular to the plane of the movement 6, more generally to the plane of the watchcase 1. Preferably, as is seen in FIGS. 1 and 2, the crown 10 is located near the edge of the aforementioned upper face and the portion of the watch constituted by the movement 6, the dial 8, the hands 9 and the crystal 5 is eccentric relative to the axis of the watchcase so as to leave room for the crown 10 and for the connection mechanism 11 and to give to the watch a particular aesthetic appearance. However, other shapes are possible for the portion 6, 8, 9, 5. The latter could for example be in the form of a circle centered on the axis of the watchcase and indented at its edge to leave room for the assembly 10, 11 or of a rectangle of which one of the corners is truncated.

The crown 10 comprises a head 13 manipulable by the user and an axial prolongation 14 that is generally cylindrical and formed in a single piece with the head 13. This axial prolongation 14 extends in the opening 15 of a crown tube 16 driven into an upper portion 17 of large cross-section of a through bore provided in the bezel 4. The opening 15 of the crown tube 16 has, seen from above (see the dotted lines in FIG. 2), an oblong shape substantially of the same width as the diameter of the prolongation 14 and oriented in a radial direction so as to permit guided radial translation of the crown 10 when this latter is in a first axial position, called an “unscrewed” position (FIGS. 3A, 3B), as will become apparent in what follows. The crown tube 16 moreover comprises an upper portion whose external lateral face, designated by 18, is screw-threaded and coacts with an internal threaded face of the crown head 13 in a second axial position of the crown 10, called “screwed” position (FIG. 1). An annular sealing gasket 19 disposed in the head 13 is compressed between the head 13 and the crown tube 16 when the crown 10 is in its screwed position.

The connection mechanism 11 connecting the crown 10 to the movement 6 comprises a cage 20 having the form of a parallelepipedal rectangle and movable in translation in the aforementioned radial direction, a generally cylindrical crown rod 21, having the same axis as the crown 10 and coacting with a narrowed distal portion 22 of the crown prolongation 14, and a control rod 23 extending in the plane of the movement 6 and in the aforementioned radial direction.

As shown in FIGS. 1, 5 and 6, the cage 20 is constituted by an upper portion 24 and a lower portion 25 assembled together by screws 26, and is disposed in a peripheral recess 27 of the circle 7, located between the bezel 4 and the back cover 2 and laterally closed by a bridge 28 fixed to the circumference of the circle 7 by screws 29. The cage 20 is mounted and guided in this recess 27 by two parallel rods 30 each having an end driven in a corresponding hole formed in the bridge 28 and the other end driven in a corresponding hole formed in the circle 7. An annular sealing gasket 31 is disposed between the upper wall of the cage 20 and the lower face of the bezel 4.

The crown rod 21 carries at its end farthest from the crown head 13, a pinion 32 located within the cage 20. This crown rod 21 passes successively through a bore 33 provided in the upper wall of the cage 20 and through a lower oblong portion of small cross-section 34 of the bore traversing the bezel 4. The pinion 32 and an annular shoulder 35 (shown in FIGS. 4A, 4B) of the crown rod 21 form abutments coacting with the upper wall of the cage 20 to fix the crown rod 21 axially to the cage 20. The diameter of the through bore 33 of the upper wall of the cage 20 is slightly greater than the diameter of the portion of the rod 21 passing through this bore 33, such that the crown rod 21 and the cage 20 are secured to one another in translation in the aforementioned radial direction whilst permitting the crown rod 21 to turn freely relative to the cage 20. An annular gasket 36 disposed in the bore 33 ensures sealing between the crown rod 21 and the cage 20.

As shown more particularly in FIGS. 4A and 4B, the narrowed distal portion 22 of the crown prolongation 14 is engaged in an axial blind hole 37 formed in the crown rod 21. This distal portion 22 comprises external coupling means 38, which couple with corresponding internal coupling means 39 of the crown rod 21 to secure in rotation the crown 10 and the crown rod 21 when the crown 10 is in an axial unscrewed position (FIGS. 3A and 4A), and which decouple from these coupling means 39 to uncouple in rotation the crown 10 and the crown rod 21 (FIG. 4B) when the crown 10 is pushed axially from its unscrewed position shown in FIGS. 3A and 4A. The coupling means 38, 39 are for example respective portions of the crown prolongation 14 and of the crown rod 21 with polygonal cross-section. It will also be noted that the crown 10 is subject to the action of a compression spring 40 mounted between the crown prolongation 14 and the bottom of the blind hole 37 and guided in a blind hole 41 of the crown prolongation 14, and that an annular internal abutment 42 of the crown rod 21 prevents the crown 10 from completely leaving the blind hole 37 by axially blocking the coupling means 38.

Referring again to FIG. 1, it will be seen that the control rod 23 also itself has a pinion 43, which pinion 43 is permanently in engagement with the pinion 32 of the crown rod 21 within the cage 20. The teeth of the pinions 32 and 43 can be straight or conical. The control rod 23 passes through a bore in the lateral wall of the cage 20 located on the side of the movement 6, and is axially secured to the cage 20, whilst remaining free in rotation, by the pinion 43 and a shoulder 44 which form abutments coacting with the aforementioned sidewall. The end of the control rod 23 opposite the pinion 43 is connected to the movement 6 in a conventional manner.

Thus, as previously indicated, the crown 10 can occupy a screwed axial position, in which position the head of the crown 13 is screwed about the crown tube 16 and the crown 10 is uncoupled from the crown rod 21 (FIGS. 1 and 4B). This screwed position is an inactive position, or rest position, permitting increasing the sealing of the watch by the compression of the gasket 19.

When the user desires to wind or set the watch, he unscrews the crown 10 to disengage it completely from the screw thread 18. Pressed by the spring 40, the crown 10 thus moves axially outwardly of the watchcase to the position shown in FIGS. 3A and 4A, in which it is retained by the abutment 42 blocking the coupling means 38. In this position, the coupling means 38 are in engagement with the coupling means 39 of the crown rod 21, fixing in rotation the crown 10 and the crown rod 21. By the coaction between the pinions 32 and 43 which are solid with the rods 21 and 23, respectively, any rotation imparted to the crown 10 is transmitted to the control rod 23. By turning the crown 10, the user can thus control the winding of the watch.

From the winding position shown in FIGS. 3A and 4A, the crown 10 can be moved radially toward the periphery of the watchcase to a second stable radial position, shown in FIG. 3B, eccentric relative to the crown tube 16. During its radial movement, the crown 10 drives with itself the connection mechanism 11, namely the crown rod 21, the cage 20 and the control rod 23. In this second radial position, a rotation of the crown 10 by the user controls the setting of the watch by driving the control rod 23. Once the setting is completed, the user returns the assembly of the crown 10 and connection mechanism 11 to its first radial position, in which the crown 10 is again centered relative to the external screw-threaded face 18 of the crown tube 16. Then he presses the crown 10 against the action of the compression spring 40, to cause movement of the crown 10 towards the back cover 2 of the watchcase, the crown rod 21 remaining itself fixed relative to the watchcase, and disconnection of the crown 10 and the crown rod 21, permitting the screwing of the crown head 13 about the screw thread 18 of the crown tube 16 without actuating the control rod 23 and hence without actuating any function of the movement 6. The two radial unscrewed stable positions of the crown 10 shown in FIGS. 3A and 3B are indexed in a conventional manner, in the movement 6, at the control rod 23. By referring to the edge of the upper face of the watchcase or to the edge of the crystal 5 (see FIG. 2), the user can visually identify in which one of these two radial unscrewed positions the crown 10 is located.

It will be noted that the invention described above is relatively simple to carry out because it does not require providing a specific movement 6 nor a specific connection between the movement 6 and the control rod 23 (in the illustrated device, the movement is merely turned 90° in its plane relative to its conventional position). This invention is also simple to use, because it permits activation of the winding and setting functions by the manipulation of a single control member, the crown 10.

On the other hand, the fact that, once unscrewed, the crown 10 must be moved laterally (which is to say perpendicularly to its axis A) rather than axially to pass from the winding position to the setting position, will produce a particular effect on the user, accustomed to crowns that can be translated only axially. This lateral movement of the crown 10 can moreover facilitate the actuation of the control rod 23 because it permits the user to pass from the winding position to the setting position, and vice versa, by pushing (laterally) the crown 10 whilst with conventional crown, pulling on the crown is necessary to pass from the winding position to the setting position.

The present invention is not limited to the winding and setting functions. The crown 10 of the invention could obviously be used to control other functions, for example functions of setting a date display mechanism separate from or integrated into the movement properly so called. In a variant, one of the two radial positions of the crown 10 could be an inactive position, in which the rotation of the crown does not actuate any particular function of the watch. Finally, if desired, there could be provided more than two stable radial positions for the crown 10.

It will also be noted that the crown 10 could be disposed other than on the upper face of the watchcase, for example on the lower face or even on the edge face of this watchcase. In this latter case, the lateral translation of the crown 10 could take place parallel to the control rod 23 and in the plane of the movement 6.

Another modification of the invention could consist in omitting the axial mobility of the crown 10 (which is to say the possibility for the crown to be screwed/unscrewed about the crown tube 16), by making the crown 10 and the crown rod 21 of one piece. In this case, the crown could be translated only radially between two or more positions, namely, typically, a winding position and a setting position.

1. Timepiece comprising a case (1), a mechanism (6) disposed in the case (1) and a rotatable control member (10) manipulable by a user, characterized in that the rotatable control member (10) is movable in translation relative to the case (1) in a direction substantially perpendicular to the axis (A) of the rotatable control member (10) between first and second positions, and in that in at least one of the first and second positions a rotation of the rotatable member (10) controls a function of the mechanism.

2. Timepiece according to claim 1, characterized in that the axis (A) of the rotatable control member (10) is substantially perpendicular to the plane of the mechanism (6).

3. Timepiece according to claim 2, characterized in that said direction is a radial direction of the case (1).

4. Timepiece according to claim 2, characterized in that the rotatable control member (10) projects from the upper face of the case (1).

5. Timepiece according to claim 4, characterized in that the rotatable control member (10) is located near an edge of said upper face.

6. Timepiece according to claim 1, characterized in that the rotatable control member (10) is connected to the mechanism (6) by connection means (11) comprising a control rod (23) connected to the mechanism (6) and extending substantially perpendicular to the axis (A) of the rotatable control member (10), in the plane of the mechanism (6) and in said direction, the connection means (11) further comprising coupling means (20, 43, 32, 21) coupling the rotatable control member (10) to the control rod (23) such that a rotation of the rotatable control member (10) causes a rotation of the control rod (23) and a translation in said direction of the rotatable control member (10) causes a same translation of the control rod (23).

7. Timepiece according to claim 6, characterized in that the coupling means comprise an element (20) movable in translation in said direction within the case (1), with which movable element (20) are secured in translation in said direction the control rod (23) and the rotatable control member (10), and in that the coupling means further comprise first and second pinions (43, 32) associated respectively with the control rod (23) and with the rotatable control member (10), located in the movable element (20) and in engagement with each other.

8. Timepiece according to claim 7, characterized in that from one of the first and second positions, the rotatable control member (10) can be pressed axially and screwed about a tube (16) secured to the case (1) without actuating any function in the mechanism (6).

9. Timepiece according to claim 8, characterized in that in its screwed position, the rotatable control member (10) compresses a gasket (19) against the tube (16).

10. Timepiece according to claim 8, characterized in that the coupling means (20, 43, 32, 21) further comprise a rod (21) having the same axis as the rotatable control member (10), this rod (21) carrying the second pinion (32) and coacting with the rotatable control member (10) such that the rotatable control member (10) be secured in rotation to the rod (21) in an unscrewed position, corresponding to one of the first and second positions, and free in rotation relative to the rod (21) in the screwed position.

11. Timepiece according to claim 1, characterized in that the mechanism (6) is the movement of the timepiece and the first and second positions correspond respectively to a winding position and a setting position.

12. Timepiece according to claim 3, characterized in that the rotatable control member (10) projects from the upper face of the case (1).

13. Timepiece according to claim 9, characterized in that the coupling means (20, 43, 32, 21) further comprise a rod (21) having the same axis as the rotatable control member (10), this rod (21) carrying the second pinion (32) and coacting with the rotatable control member (10) such that the rotatable control member (10) be secured in rotation to the rod (21) in an unscrewed position, corresponding to one of the first and second positions, and free in rotation relative to the rod (21) in the screwed position.

14. Timepiece according to claim 1, characterized in that from one of the first and second positions, the rotatable control member (10) can be pressed axially and screwed about a tube (16) secured to the case (1) without actuating any function in the mechanism (6).
